(19) United States
(12) Patent Application Publication
(10) Pub. No.: US 2015/0266267 A1
(43) Pub. Date: Sep. 24, 2015

(54) COPPER CLAD LAMINATE AND METHOD FOR MANUFACTURING THE SAME

(71) Applicant: NATIONAL TAIPEI UNIVERSITY OF TECHNOLOGY, TAIPEI (TW)

(72) Inventors: Syng-Peng Rwei, Taipei City (TW); Yung-Tan Lin, Mailiao Township (TW)

(73) Assignee: NATIONAL TAIPEI UNIVERSITY OF TECHNOLOGY, Taipei (TW)

(21) Appl. No.: 14/221,320

(22) Filed: Mar. 21, 2014

(51) Int. Cl. B32B 5/26; B32B 37/06; B32B 37/24; B32B 38/08; B32B 15/14; B32B 5/02

(52) U.S. Cl. CPC B32B 5/26; B32B 15/14; B32B 5/024; B32B 37/24; B32B 38/08; B32B 37/06; B32B 2260/046; B32B 2262/0253; B32B 2457/08; B32B 2262/101; B32B 2037/243

(57) ABSTRACT

A copper clad laminate is introduced. Cyclic olefin copolymer fabric functions as a base fabric for manufacturing the copper clad laminate to reduce dielectric constant (Dₖ) and dissipation factor (D_{f}) of the copper clad laminate. The flame-retarded curing agent included in the resin for use in manufacturing the copper clad laminate is halogen-free and does not cause environmental pollution. The cyclic phosphate structure of the flame-retarded curing agent enhances thermal stability and chemical stability of the copper clad laminate thus manufactured. During the manufacturing process of the copper clad laminate, an annealing process is performed while thermal curing and lamination is taking place to prevent bending otherwise resulting from a difference in thermal expansion coefficient between cyclic olefin copolymer fabric and glass fiber fabric.

### FIELD OF TECHNOLOGY

The present invention relates to copper clad laminates (CCL) for use with printed circuit boards, and more particularly, to a copper clad laminate with a cyclic olefin copolymer fabric and a method for manufacturing the same.

### BACKGROUND

Lightweight, compact, all-in-one, and multifunctional consumer electronic products are all the rage. Hence, printed circuit boards (PCB) for use with the aforesaid electronic products have a trend toward high density and high integration, thereby leading to the increasingly strict functional requirements of the printed circuit boards in terms of electrical properties and flame retardation.

As regards their electrical properties, the printed circuit boards are expected to be made of materials with a low dielectric constant with a view to not only speeding up the transmission of electronic signals across the materials but also reducing the mutual interference of the electronic signals during the transmission process thereof and reducing energy loss.

In this regard, copper clad laminates (CCL) are deemed the most important constituent element for use in manufacturing substrates of the printed circuit boards. PCB manufacturing methods depend on the materials of which the substrates of the printed circuit boards are made. At present, FR4 (DICY Cured) has the largest global market share of PCB substrates, but it demonstrates an overly large dielectric constant of 4.3˜4.8 and thus still has room for improvement.

Moreover, the raw material of which laminates for use with high-frequency printed circuit boards are mainly made include PTFE (polytetrafluoroethylene) resins and PPO (Poly phenyl oxide) resins. Although the PTFE resins have very low dielectric constant values, their raw material costs are high, and their raw materials are difficult to process; as a result, their laminate manufacturing process is unique and expensive. Hence, PTFE-based laminates are basically applied to special fields where the required frequency is higher than 3 GHz. The printed circuit boards made of PTFE resins are applied to sophisticated instruments and expensive electronic products, and therefore have never been in wide use. In view of this, General Electric (GE) manufactures laminate GETEK® for use in printed circuit boards, using PPO resins, to achieve a dielectric constant of 4.0 approximately, which results in poor material properties.

In view of the aforesaid drawbacks arising from the dielectric constant of the conventional copper clad laminate (CCL), the prior art mostly attempts to improve the overly high dielectric constant of the related resins in vain and thus fails to reduce the dielectric constant of the conventional copper clad laminate (CCL) significantly.

Moreover, the resins for use in the conventional copper clad laminate (CCL) comprise a flame retardant, and the flame retardant is usually made of bromide which is a halogen compound notorious for causing environmental pollution. In view of this, related international organizations set forth strict requirements of the halogen content of copper clad laminates (CCL). Therefore, the industrial sector's demand for halogen-free flame retardants is on the rise. Furthermore, existing substitutes for the aforesaid flame retardants usually demonstrate unsatisfactory thermal stability and chemical stability; as a result, the substitutes can hardly replace halogen-containing flame retardants effectively and widely.

### SUMMARY

In view of the aforesaid drawbacks of the prior art, it is an objective of the present invention to provide a copper clad laminate (CCL) with an improved base fabric for solving the problem with an overly high dielectric constant. Moreover, the present invention further discloses a derivative of a phosphorus-containing flame retardant with a view to preventing environmental pollution otherwise caused by halogen compounds. The present invention further discloses a cyclic phosphate structure in a derivative of the phosphorus-containing flame retardant with a view to enhancing the thermal stability and chemical stability of the flame retardant.

In order to achieve the above and other objectives, the present invention provides a copper clad laminate (CCL), comprising: a plurality of prepregs stacked in a low-to-high sequence and each comprising a base fabric and a resin enclosing the base fabric, the base fabric being one of a cyclic olefin copolymer (COC) fabric and a glass fiber fabric, wherein the base fabric of at least one of the prepregs is a COC fabric; and a copper foil laminated against the prepregs.

In an embodiment of the present invention, regarding the copper clad laminate, the base fabric of the highest prepreg and the base fabric of the lowest prepreg are the COC fabrics.

In another embodiment of the present invention, regarding the copper clad laminate, the base fabrics of the prepregs are COC fabrics.

In yet another embodiment of the present invention, the resin of the copper clad laminate comprises the flame-retarded curing agent expressed by at least one of formula (1), formula (2), and formula (3) below:

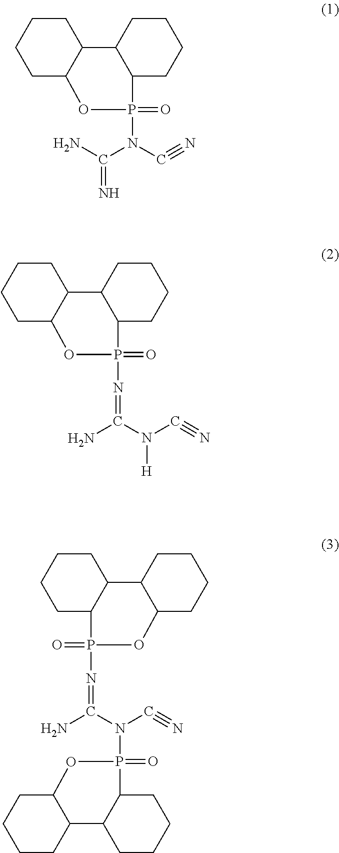 [SMILES: N#CN(C(=N)N)P1(=O)OC2CCCCC2C2CCCCC21 ; N#CNC(N)=NP1(=O)OC2CCCCC2C2CCCCC21 ; N#CN(C(N)=NP1(=O)OC2CCCCC2C2CCCCC21)P1(=O)OC2CCCCC2C2CCCCC21]

In order to achieve the above and other objectives, the present invention further provides a copper clad laminate (CCL) manufacturing method, comprising the steps of: providing a resin and a plurality of base fabrics, wherein the base fabrics are each a COC fabric or a glass fiber fabric, and the base fabrics include at least a COC fabric; impregnating the base fabrics in the resin; bake-drying the base fabrics impregnated in the resin to form prepregs; and stacking the prepregs in a low-to-high sequence, putting a copper foil on top of the prepregs, and performing thermal curing and lamination to form a copper clad laminate.

In an embodiment of the present invention, regarding the copper clad laminate, the base fabric of the highest prepreg and the base fabric of the lowest prepreg are the COC fabrics.

Furthermore, in another embodiment of the present invention, regarding the copper clad laminate, the base fabrics of the prepregs are COC fabrics.

Furthermore, in yet another embodiment of the present invention, thermal curing and lamination of the copper clad and the prepregs is followed by an annealing process performed thereon.

The annealing process entails using both the COC fabric and glass fiber fabric as the base fabric of the copper clad laminate to achieve copper clad laminate height evenness which might otherwise be rendered impossible because of thermal expansion warpage.

Furthermore, the annealing process is performed at an annealing temperature of 90 C.° to 150 C.° for at least 30 minutes.

Moreover, In an embodiment of the present invention, the thermal curing and lamination occurs at a lamination temperature of 175 C.° to 200 C.°.

In conclusion, a copper clad laminate manufactured by the manufacturing method is characterized in that: a COC fabric-made base fabric replaces a glass fiber-made base fabric to reduce the numeric values of the electrical properties, such as a dielectric constant and a dissipation factor, of the copper clad laminate; the dielectric constant achieved can be as low as 2.5, whereas the dissipation factor achieved can be as low as 0.0004; the dielectric constant value is calculated by measuring a surface resistance value, whereas the dissipation factor is calculated by a total electron runaway speed; hence, the dielectric constant value can be significantly reduced by putting the COC fabric at the top and bottom of the copper clad laminate, whereas the dissipation factor can be minimized by maximizing the proportion of the COC fabric in the copper clad laminate.

Moreover, the flame-retarded curing agents synthesized and expressed by formulas (1), (2), (3) of the present invention are phosphates and halogen-free and thereby prevent environmental pollution which might otherwise occur in the course of the use and recycling thereof. Due to its ring-shaped molecular structure, the flame-retarded curing agents have higher thermal stability and chemical stability than conventional acyclic phosphates. Moreover, a related test discovers that an appropriate amount of the flame-retarded curing agents can be added to the resin to allow the copper clad laminate to meet UL-94 V0 flame retardation standard.

### BRIEF DESCRIPTION

Objectives, features, and advantages of the present invention are hereunder illustrated with specific embodiments in conjunction with the accompanying drawings, in which:

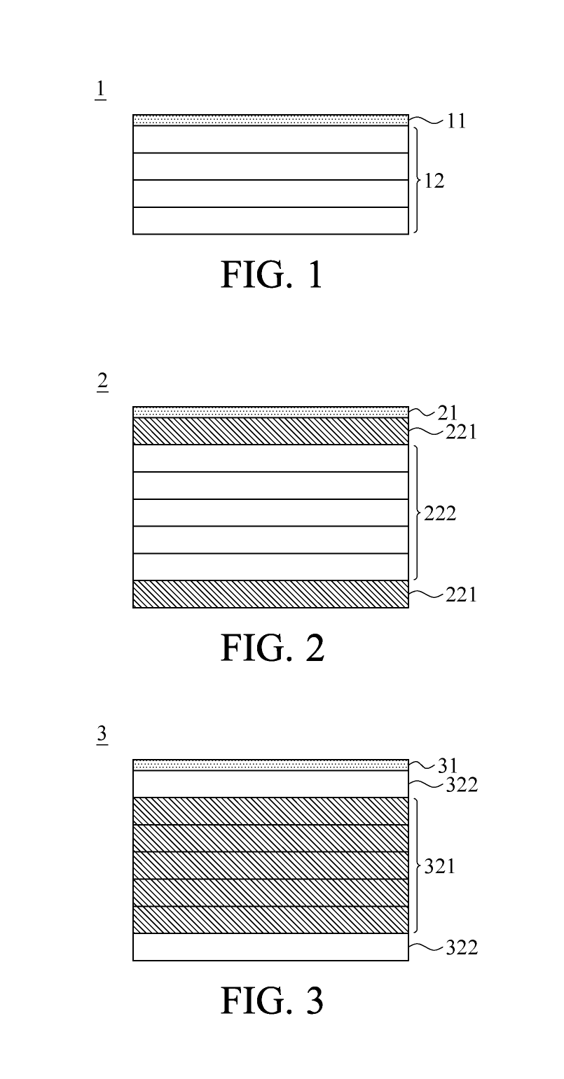

FIG. 1 is a schematic view of a build-up structure of copper clad laminate (CCL) of the present invention;

FIG. 2 is a schematic view of the CCL build-up structure according to embodiment 1 of the present invention;

FIG. 3 is a schematic view the CCL build-up structure according to embodiment 2 of the present invention;

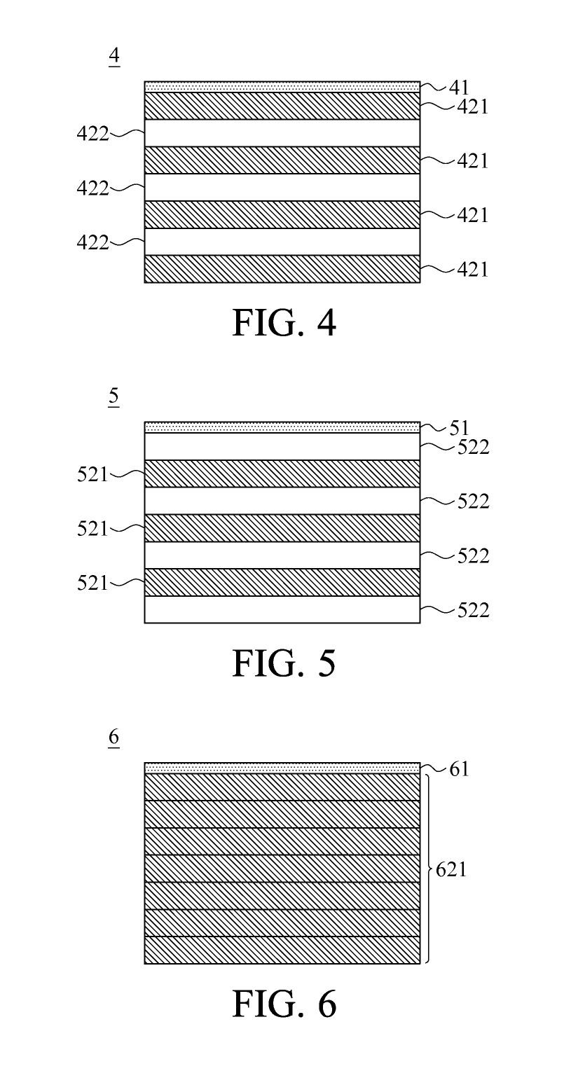

FIG. 4 is a schematic view of the CCL build-up structure according to embodiment 3 of the present invention;

FIG. 5 is a schematic view of the CCL build-up structure according to embodiment 4 of the present invention; and

FIG. 6 is a schematic view of the CCL build-up structure according to embodiment 5 of the present invention.

### DETAILED DESCRIPTION

### Definitions

The indefinite articles “a” and “an” and the numeric expression “one” used herein are intended to describe a copper clad laminate and a method for manufacturing the same of the present invention in terms of elements and compositions for illustrative sake and general conceptual description of the present invention. Furthermore, the indefinite articles “a” and “an” and the numeric expression “one” used herein may imply “at least a/an” and “at least one” as needed, whereas any ensuing singular noun used herein may imply the corresponding plural noun unless otherwise specified.

Where quantity, concentration or any value or parameter is expressed by a range, a preferred range, an upper limit, and/or a lower limit, it must be interpreted as falling within the range between the upper limit or preferred value and the lower limit or preferred value, regardless of whether the range is disclosed. Moreover, unless otherwise specified, in case a range of values is disclosed herein, the range of values must cover its endpoints as well as all the integers and fractions which fall within the range of values.

According to the present invention, a numeric value must be interpreted in a way to demonstrate the precision attributable to the significant figures thereof, provided that the objectives of the invention are achievable. For instance, the number 40 must be interpreted to cover the range from 35.0 to 44.9, and the number 40.0 must be interpreted to cover the range from 39.50 to 40.49.

### Raw Materials

Changchun epoxy resin (model no. CNE-200ELF and BE501, purchased from CHANG CHUN PLASTICS CO., LTD.), a curing agent which is dicyandiamide (Dicy), a flame retardant agent which is 9,10-dihydro-9-oxa-10-phosphaphenanthrene-10-oxide (DOPO) and a solvent which is dimethylformamide (DMF). The aforesaid raw materials are commercially available as they can be directly purchased from the market, and they need not be purified before direct use.

### Flame-Retarded Curing Agent

In an embodiment of the present invention, the present invention provides a halogen-free flame-retarded curing agent which demonstrates enhanced thermal stability and chemical stability and is capable of high flame retardation and curing.

The flame-retarded curing agent is a translucent brownish-yellow solid produced by mixing DOPO and Dicy at 100 C.˜140 C.° for 6 hours and then cooling the mixture until its temperature drops to the room temperature.

The chemical structure of the compound contained in the resultant flame-retarded curing agent (DOPO-Dicy) is expressed by at least one of the formulas (1) through (3) as follows:

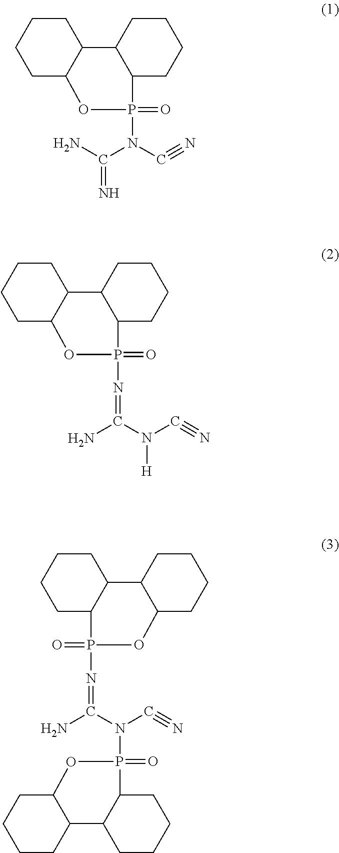 [SMILES: N#CN(C(=N)N)P1(=O)OC2CCCCC2C2CCCCC21 ; N#CNC(N)=NP1(=O)OC2CCCCC2C2CCCCC21 ; N#CN(C(N)=NP1(=O)OC2CCCCC2C2CCCCC21)P1(=O)OC2CCCCC2C2CCCCC21]

The amide group of the flame-retarded curing agent (DOPO-Dicy) is highly hygroscopic and thus absorbs water readily when kept in an atmospheric environment. The high water content of the flame-retarded curing agent (DOPO-Dicy) leads to the uneven thermal curing of the flame-retarded curing agent (DOPO-Dicy) and the epoxy resin during a subsequent process of lamination of a copper clad laminate (CCL). Hence, before it is put to use, the flame-retarded curing agent (DOPO-Dicy) must be dried until its water content is reduced to 800 ppm or lower.

### Fabric

In an embodiment of the present invention, the base fabric for use in the copper clad laminate comprises a cyclic olefin copolymer (COC) fabric which is produced by winding COC fiber with polyvinyl alcohol (PVA) fiber to form a core-spun yarn, warping and beating-up the core-spun yarn to produce a plain woven fabric with a gauge of 50×37 pieces/inch and a thickness of 0.2 mm, then rinsing the woven fabric in hot water at 80 C.° and for 30 minutes, and eventually removing the PVA fiber to finalize the COC fabric.

Both the warp and weft of the COC fabric are formed from COC fiber. The COC fiber has a low dielectric constant, and thus the COC fabric has a low dielectric constant too.

wCopper Clad Laminate and Manufacturing Process Thereof

### [Copper Clad Laminate]

Referring to FIG. 1, a copper clad laminate 1 of the present invention comprises a plurality of prepregs 12 and a copper clad 11 disposed on the prepregs 12, wherein the prepregs 12 are stacked up and are each formed from resin and base fabric. The base fabric for use in the prepregs 12 either comprises COC fabric and glass fiber fabric or comprises COC fabric. Furthermore, regarding their quantity, the prepregs are provided in the number of 4 to 12, for example.

Referring to FIG. 2 through FIG. 6, there are shown schematic views of a copper clad laminate according to embodiment 1 through embodiment 5 of the present invention, respectively, wherein the copper clad laminate comprises seven prepregs. Referring to FIG. 2, highest and lowest prepregs 221 of a copper clad laminate 2 are made from COC fabric, whereas five intermediate prepregs 222 of the copper clad laminate 2 are made from glass fiber fabric. Referring to FIG. 3, highest and lowest prepregs 322 of a copper clad laminate 3 are made from glass fiber fabric, whereas five intermediate prepregs 321 of the copper clad laminate 3 are made from COC fabric. Referring to FIG. 4 and FIG. 5, prepregs made from COC fabric alternate with prepregs made from glass fiber fabric. FIG. 4 shows that highest and lowest prepregs 421 are made from COC fabric. FIG. 5 shows that highest and lowest prepregs 522 are made from glass fiber fabric. Referring to FIG. 6, all the prepregs, that is, prepregs 621, of a copper clad laminate 6 are made from COC fabric.

Moreover, to contrast with the copper clad laminates in the above embodiments, the present invention further provides a comparative embodiment in which a copper clad laminate has all its base fabric made from glass fiber fabric, though its other constituent materials and build-up structure are identical to their counterparts in the above embodiments. The glass fiber fabrics are commercially available products on an electronic basis (product no. 7628) with a gauge of 44×33 pieces/inch and a thickness of 0.18 mm.

### [Description of Manufacturing Process]

During the manufacturing process of the copper clad laminates, the resin in the embodiments and the comparative embodiment of the present invention is a mixture of ingredients whose proportions are appropriately controlled to control the extent of curing. Experiments are conducted, using different resin formulas and proportions shown in Table 1, wherein, during the experiments, the copper clad laminates are subjected to a hot pressing pressure of 20 kg/cm², at a hot pressing temperature of 185 C.°, and for a hot pressing duration of 2 hours to identify the best resin formula.

TABLE 1
resin formulas

| | Feed (g) | | | | | Gel Time |
|---|---|---|---|---|---|---|
| Formula | | | | | 2-MI | (gel time) |
| No. | CNE-200 | DOPO-Dicy | DMF | SiO₂ | (10%) | (sec) |
| 1 | 500 | 19 | 200 | 150 | 0.05 | 153 |
| 2 | 500 | 19 | 200 | 150 | 0.1 | 98 |
| 3 | 500 | 23 | 200 | 150 | 0.05 | 128 |
| 4 | 500 | 23 | 200 | 150 | 0.1 | 85 |
| 5 | 500 | 27 | 200 | 150 | 0.1 | 61 |

CNE-200, which is the model number for epoxy resin, dissolves in acetone to achieve a solid content of 70%, and can be purchased from the market. 2-MI denotes 2-methyl imidazole which is a curing promoter administered at a usage unit of 0.05 PHR. DOPO-Dicy denotes the flame-retarded curing agent of the present invention. DMF denotes dimethylformamide.

Given the optimal curing time of 180 seconds during the manufacturing process of the copper clad laminates, Table 1 shows that the gel time of formula 1 approximates to 180 seconds. Hence, the copper clad laminates are manufactured in accordance with resin formula 1.

Afterward, the copper clad laminate manufacturing process begins with formula 1 and involves dissolving the flame-retarded curing agent (DOPO-Dicy) in DMF, mixing them with epoxy resin and a filler, thinning the mixture with acetone until the viscosity of the mixture is appropriate so as to form a varnish, confirming the gel time at an electric hot plate of 170 C.°, setting the impregnation time to two-thirds of the gel time, performing impregnation of the varnish at the room temperature and in the presence of the base fabric, bake drying the impregnated varnish at 165 C.° with a hot air oven to produce prepregs, stacking 7 prepregs and 1 oz of copper clad at 185 C.° to perform thermal curing and lamination thereon under a hot pressing pressure of 20 kg/cm², wherein its temperature-rising process takes place step by step: raising the temperature from 35 C.° for 11 minutes, heating, after the temperature has reached 85 C.°, for another 20 minutes without raising the temperature, raising the temperature from 85 C.° for 45 minutes until the temperature reaches 185 C.°, and heating at 185 C.° for 120 minutes. Upon completion of the temperature-rising process, the thermal curing and lamination process is finished.

Understandably, according to the present invention, in an embodiment for use in an equivalent change, the temperature at which the thermal curing and lamination process takes place ranges between 175 C.° and 200 C.°.

COC fabric differs from glass fiber fabric in terms of thermal expansion coefficient, and thus the present invention is exemplified by two different base fabrics illustrated with embodiment 1 through embodiment 4. As a result, upon completion of the thermal curing and lamination process, warpage happens to the copper clad laminate, causing a difference of at least 3 mm between the height of the center of the laminate and the height of the periphery of the laminate. Furthermore, in embodiment 5, warpage does not happen to the copper clad laminate, because its base fabric is always COC fabric.

Hence, in embodiment 1 through embodiment 4, after the temperature of thermal curing and lamination has reached 185 C.°, an annealing process begins; in other words, the thermal curing and lamination process will stop, only if a cooling process follows the temperature-rising process. Table 2 enumerates the differences between the height of the center of the laminate and the height of the periphery of the laminate in embodiment 1 through embodiment 4, wherein the annealing processes are performed at different temperatures, respectively, for 30 minutes.

TABLE 2
effect of annealing temperature on warpage

| annealing | difference in height (mm) | | | |
|---|---|---|---|---|
| temperature | embodiment | embodiment | embodiment | embodiment |
| (C. °) | 1 | 2 | 3 | 4 |
| not yet | 3.1 | 3.6 | 4.6 | 4.2 |
| annealed (room | | | | |
| temperature) | | | | |
| 80 | 1.9 | 2.3 | 4.1 | 3.8 |
| 100 | 0 | 0.8 | 2.1 | 1.7 |
| 120 | 0 | 0 | 0 | 0 |

As shown in Table 2, when the annealing temperature increases to 100 C.°, only the copper clad laminate of embodiment 1 meets the requirement of height evenness, whereas warpage still happens to the copper clad laminates in embodiments 2, 3, 4. At the annealing temperature 120 C.°, the copper clad laminates in embodiment 1 through embodiment 4 meet the requirement of height evenness, as Table 2 shows that they have a height difference of 0 mm. The result of Table 2 indicates that, to meet the requirement of height evenness of copper clad laminate, it is necessary that an annealing process must be performed at 120 C.° for an additional period of 30 minutes in the case of copper clad laminates which comprises COC fabric and glass fiber fabric. The annealing temperature for a copper clad laminate depends on how many prepregs of the copper clad laminate are stacked up and how the prepregs are stacked up. Hence, according to the present invention, in an embodiment for use in an equivalent change, the annealing temperature is 90 C.° ˜150 C.°, and the annealing duration is adjustable according to the annealing temperature.

### Measurement of High Flame Retardation

Regarding the measurement of high flame retardation of copper clad laminates of the present invention, the flame retardation level of the copper clad laminates is determined by UL-94 standard.

According to the present invention, a derivative (DOPO-Dicy) of DOPO is added to epoxy resin to function as a curing agent for the epoxy resin, enhance the flame retardation capability and thermal stability of the epoxy resin, and, more importantly, prevent environmental pollution which might otherwise arise from the use of bromide epoxy resin and occur in the course of the use and recycling thereof.

Due to the reduction in the cross-linking density of the cured epoxy resin as a result of the introduction of a phosphorus-containing flame retardant, Td decreases but remains higher than 300 C.° and thus meets the thermal stability requirement (>288 C.°) of copper clad laminates. During the heating process, the phosphorus-containing residual of the phosphorus-containing group of the resin is conducive to the enhancement of the flame retardation of the laminates.

Table 4 enumerates the measured flame retardation-related data of the copper clad laminates manufactured from resins with different phosphorus content in the embodiments, to allow persons skilled in the art to gain insight into the flame retardation capability of a flame-retarded curing agent of the present invention and prove that the flame-retarded curing agent of the present invention is effective in achieving flame retardation.

TABLE 4
flame retardation performance of cured laminates with different
phosphorus content

| | | average | | |
|---|---|---|---|---|
| | | combustion | | |
| | phosphorus | time | | |
| | content (ppm) | (T₁ + T₂)S | smoke | UL-94 |
| embodiment 1 | 11000 | 7.6 | nil | V0 |
| embodiment 2 | 9500 | 3.8 | nil | V0 |
| embodiment 3 | 12500 | 6.4 | nil | V0 |
| embodiment 4 | 9000 | 3.5 | nil | V0 |
| embodiment 5 | 13000 | 6.2 | trace | V0 |

As indicated by Table 4, when phosphorus content exceeds 13000 ppm, the laminate (embodiment 5) manufactured solely from COC fabric has a flame retardation level of UL-94 V0. Referring to FIG. 2 through FIG. 5 for the way of stacking up glass fiber fabric and COC fabric and Table 4, the required phosphorus content is much higher for the laminate enclosed by COC fabric than for the laminate enclosed by glass fiber fabric, so is it when COC fabric accounts for more than 50% of the composition of the copper clad laminate. It is because the degradation of the phosphorus-containing group in the phosphorus-containing epoxy resin is conducive to increasing the degradation temperature, and a carbonized substance encloses the laminate to function as a flame retardation layer, thereby enhancing flame retardation.

### Measurement and Comparison of Electrical Properties of Copper Clad Laminate

According to the present invention, physical properties, such as electrical properties, of the copper clad laminates are measured by a dielectrometer.

COC fabric has a low dielectric constant (DO of about 2.3 and a low dissipation factor (D_{f}) of about 0.00007. The electrical properties of the copper clad laminates of the present invention are measured according to different ways of stacking up the glass fiber fabric and COC fabric.

Table 3 shows the data related to the analysis of the electrical properties of the copper clad laminates in the embodiment 1 through embodiment 5 and the comparative embodiment.

TABLE 3
comparison of dielectric constant (Dₖ) and dissipation factor (D_{f})

| | embodiment | | embodiment | | embodiment | | embodiment | | embodiment | | comparative | |
|---|---|---|---|---|---|---|---|---|---|---|---|---|
| | 1 | | 2 | | 3 | | 4 | | 5 | | embodiment | |
| frequency | Dₖ | D_{f} | Dₖ | D_{f} | Dₖ | D_{f} | Dₖ | D_{f} | Dₖ | D_{f} | Dₖ | D_{f} |
| 1 MHz | 3.3 | 0.013 | 4.3 | 0.015 | 3 | 0.01 | 3.8 | 0.013 | 2.5 | 0.008 | 4.6 | 0.018 |
| 1 GHz | 3.1 | 0.02 | 3.3 | 0.006 | 2.9 | 0.008 | 3.2 | 0.0095 | 2.8 | 0.0005 | 3.5 | 0.026 |
| 2 GHz | 3.1 | 0.024 | 3.3 | 0.002 | 2.9 | 0.005 | 3 | 0.007 | 2.8 | 0.0004 | 3.4 | 0.031 |
| 5 GHz | 2.9 | 0.03 | 3.2 | 0.002 | 2.7 | 0.005 | 3 | 0.007 | 2.7 | 0.0004 | 3.4 | 0.035 |

Referring to Table 3, where the dielectric constant is measured by a IPC-TM-650 test standard method, the dielectric constant of the copper clad laminate of embodiment 5 is, from 1 MHz to 5 GHz, lower than the dielectric constant of the copper clad laminate of the comparative embodiment, with a maximum difference of 2.1. Referring to Table 3, the copper clad laminate will have a low dielectric constant, provided that the base fabric of the highest prepreg and the base fabric of the lowest prepreg are the COC fabrics, for example, in embodiment 1 (FIG. 2) and embodiment 3 (FIG. 4); hence, the dielectric constant of a copper clad laminate is correlated with the position of the COC fabric-made base fabric at the copper clad laminate, but is not correlated with the proportion of COC fabric in the copper clad laminate.

Furthermore, as indicated by the data pertaining to the dissipation factor of the copper clad laminates and shown in Table 3, among the copper clad laminates in embodiments 1-5, the copper clad laminate in embodiment 5 has the least dissipation factor and has the obviously lowest dissipation factor of 0.0004 at high frequency compared with the dissipation factor of 0.035 in the comparative embodiment. The dissipation factor of the copper clad laminates correlates with the proportion of COC fabric in the copper clad laminates. Referring to Table 3, at a frequency of 5 GHz, the copper clad laminate made solely from COC fabric (as in embodiment 5) has the least dissipation factor (0.0004), embodiment 2 (FIG. 3) comes second, embodiment 3 (FIG. 4) comes third, and the copper clad laminate made solely from glass fiber fabric (as in comparative embodiment) has the largest dissipation factor (0.035).

In conclusion, the dielectric constant of a copper clad laminate depends on the position of COC fabric at the copper clad laminate, whereas the dissipation factor of a copper clad laminate correlates with the proportion of COC fabric in the copper clad laminate.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A copper clad laminate (CCL), comprising:
a plurality of prepregs stacked in a low-to-high sequence and each comprising a base fabric and a resin enclosing the base fabric, the base fabric being one of a cyclic olefin copolymer (COC) fabric and a glass fiber fabric, wherein the base fabric of at least one of the prepregs is a COC fabric; and
a copper foil laminated against the prepregs.

2. The copper clad laminate of claim 1, wherein the base fabric of the highest prepreg and the base fabric of the lowest prepreg are the COC fabrics.

3. The copper clad laminate of claim 1, wherein the base fabrics of the prepregs are COC fabrics.

4. The copper clad laminate of claim 1, wherein the resin comprises the flame-retarded curing agent expressed by at least one of formula (1), formula (2), and formula (3) below:

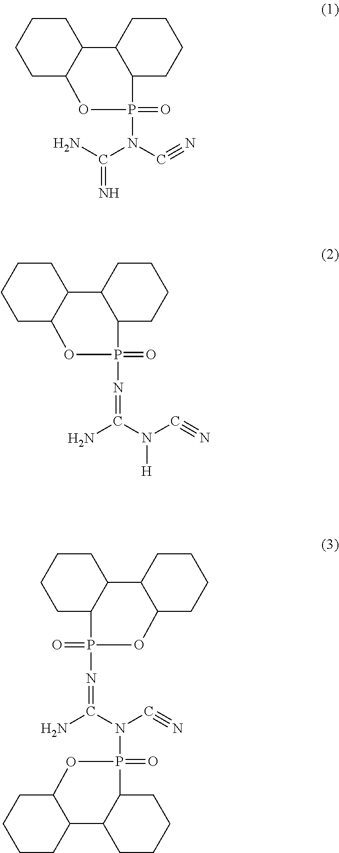 [SMILES: N#CN(C(=N)N)P1(=O)OC2CCCCC2C2CCCCC21 ; N#CNC(N)=NP1(=O)OC2CCCCC2C2CCCCC21 ; N#CN(C(N)=NP1(=O)OC2CCCCC2C2CCCCC21)P1(=O)OC2CCCCC2C2CCCCC21]

5. The copper clad laminate of claim 2, wherein the resin comprises the flame-retarded curing agent expressed by at least one of formula (1), formula (2), and formula (3) below:

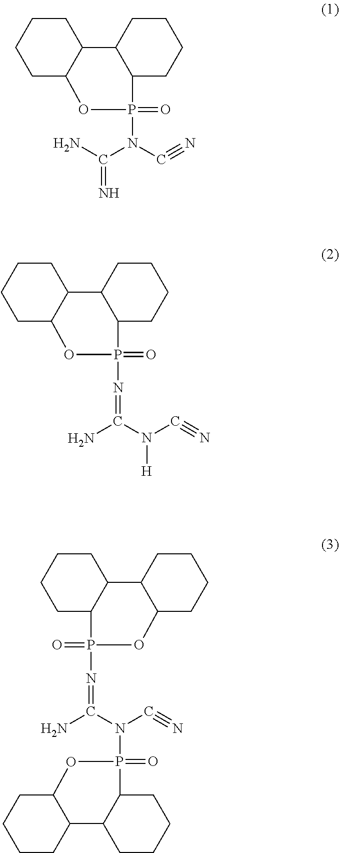 [SMILES: N#CN(C(=N)N)P1(=O)OC2CCCCC2C2CCCCC21 ; N#CNC(N)=NP1(=O)OC2CCCCC2C2CCCCC21 ; N#CN(C(N)=NP1(=O)OC2CCCCC2C2CCCCC21)P1(=O)OC2CCCCC2C2CCCCC21]

6. The copper clad laminate of claim 3, wherein the resin comprises the flame-retarded curing agent expressed by at least one of formula (1), formula (2), and formula (3) below:

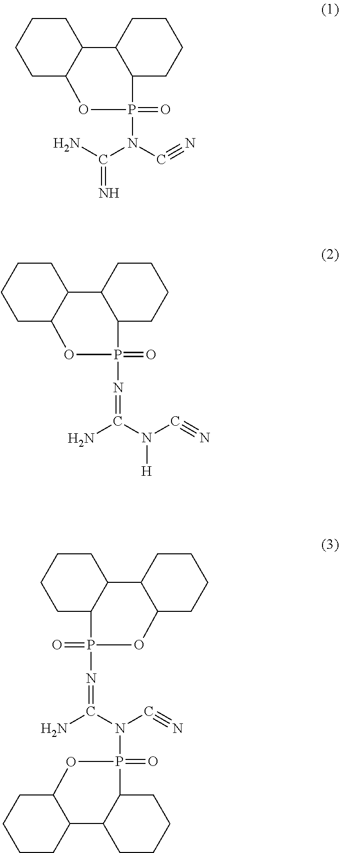 [SMILES: N#CN(C(=N)N)P1(=O)OC2CCCCC2C2CCCCC21 ; N#CNC(N)=NP1(=O)OC2CCCCC2C2CCCCC21 ; N#CN(C(N)=NP1(=O)OC2CCCCC2C2CCCCC21)P1(=O)OC2CCCCC2C2CCCCC21]

7. A copper clad laminate (CCL) manufacturing method, comprising the steps of:
providing a resin and a plurality of base fabrics, wherein the base fabrics are each a COC fabric or a glass fiber fabric, and the base fabrics include at least a COC fabric;
impregnating the base fabrics in the resin;
bake-drying the base fabrics impregnated in the resin to form prepregs; and
stacking the prepregs in a low-to-high sequence, putting a copper foil on top of the prepregs, and performing thermal curing and lamination to form a copper clad laminate.

8. The copper clad laminate of claim 7, wherein the base fabric of the highest prepreg and the base fabric of the lowest prepreg are the COC fabrics.

9. The copper clad laminate of claim 7, wherein the base fabrics of the prepregs are COC fabrics.

10. The manufacturing method of claim 7, wherein thermal curing and lamination of the copper clad and the prepregs is followed by an annealing process performed thereon.

11. The manufacturing method of claim 10, wherein the annealing process is performed at an annealing temperature of 90 C.° to 150 C.° for at least 30 minutes.

12. The manufacturing method of claim 7, wherein thermal curing and lamination occurs at a lamination temperature of 175 C.° to 200 C.°.

13. The manufacturing method of claim 8, wherein thermal curing and lamination occurs at a lamination temperature of 175 C.° to 200 C.°.

14. The manufacturing method of claim 9, wherein thermal curing and lamination occurs at a lamination temperature of 175 C.° to 200 C.°.

15. The manufacturing method of claim 10, wherein thermal curing and lamination occurs at a lamination temperature of 175 C.° to 200 C.°.

16. The manufacturing method of claim 11, wherein thermal curing and lamination occurs at a lamination temperature of 175 C.° to 200 C.°.
